(19) United States
(12) Patent Application Publication
(10) Pub. No.: US 2013/0328384 A1
(43) Pub. Date: Dec. 12, 2013

(54) WHEEL HUB WITH AN AXIAL-BRAKING ASSEMBLY FOR A TRICYCLE

(71) Applicant: Pei-Hsing WANG, Taichung City (TW)

(72) Inventor: Pei-Hsing WANG, Taichung City (TW)

(21) Appl. No.: 13/493,368

(22) Filed: Jun. 11, 2012

(51) Int. Cl. B60B 27/00

(52) U.S. Cl. 301/110.5

(57) ABSTRACT

A wheel hub with an axial-braking assembly for a wheel hub has an axle device and a braking device. The axle device has an axle, a hub, a wheel mount and a fixing mount. The hub is mounted around the axle. The wheel mount is securely mounted around the axle and has a threaded sleeve. The fixing mount is mounted around the axle. The braking device is connected to the axle device and has a pressing jacket, an engaging mount, a spring, two friction slices and a holding arm. The pressing jacket is mounted in the hub, is rotatably connected to the wheel mount and has an abutting inclined plane. The engaging mount is mounted in the hub and is connected to the fixing mount. The friction slices are mounted in the hub and are mounted around the pressing jacket at intervals. The holding arm is securely mounted around the fixing mount.

### BACKGROUND OF THE INVENTION

1. Field of the Invention

The present invention relates to wheel hub and more particularly to a wheel hub with an axial-braking assembly for a tricycle to be operated conveniently and to provide an accurate braking effect for the tricycle.

2. Description of Related Art

A conventional tricycle is directly driven by rider's feet stepping the pedals of the tricycle to provide a motive force to the front wheel of the tricycle without using a chain device. To stop or slow down the conventional tricycle, the rider's feet contact and rub against the ground to provide a braking force to the conventional tricycle. Therefore, the conventional tricycle cannot be braked immediately and accurately. In addition, it is inconvenient in use and may wear and tear the rider's shoes.

A wheel hub with an axial-braking assembly for a tricycle in accordance with the present invention mitigates or obviates the aforementioned problems.

### SUMMARY OF THE INVENTION

The main objective of the present invention is to provide a wheel hub and more particularly to a wheel hub with an axial-braking assembly for a tricycle that can be operated conveniently and can provide an accurate braking effect for the tricycle.

The wheel hub with an axial-braking assembly for a tricycle in accordance with the present invention has an axle device and a braking device. The axle device has an axle, a hub, a wheel mount and a fixing mount. The hub is mounted around the axle. The wheel mount is securely mounted around the axle and has a threaded sleeve. The fixing mount is mounted around the axle. The braking device is connected to the axle device and has a pressing jacket, an engaging mount, a spring, two friction slices and a holding arm. The pressing jacket is mounted in the hub, is rotatably connected to the wheel mount and has an abutting inclined plane. The engaging mount is mounted in the hub and is connected to the fixing mount. The friction slices are mounted in the hub and are mounted around the pressing jacket at intervals. The holding arm is securely mounted around the fixing mount.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a wheel hub with an axial-braking assembly for a tricycle in accordance with the present invention;

FIG. 2 is an operational side view of the wheel hub in FIG. 1 mounted with a front fork and a front wheel of a tricycle;

FIG. 3 is an exploded perspective view of the wheel hub in FIG. 1;

FIG. 4 is a side view in partial section of the wheel hub in FIG. 1;

FIG. 5 is an operational side view in partial section of the wheel hub in FIG. 4 when the axial-braking assembly is braked; and

FIG. 6 is an operational cross sectional end view of the wheel hub along line 6-6 in FIG. 5.

### DETAILED DESCRIPTION OF THE PREFERRED EMBODIMENT

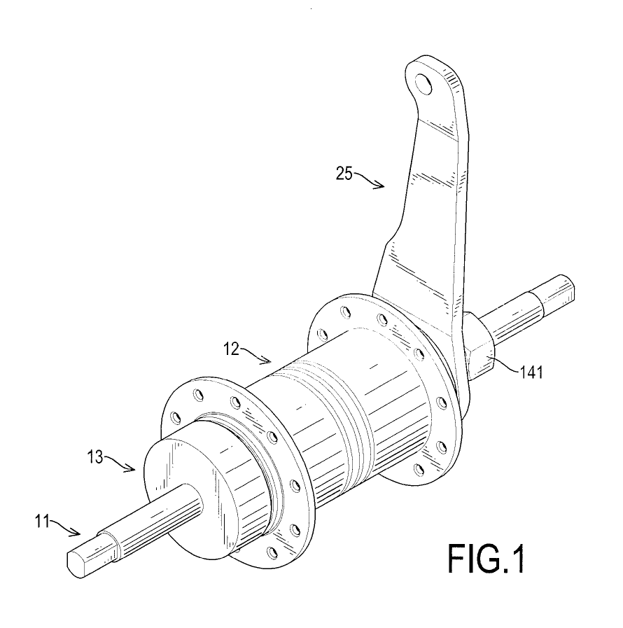

With reference to FIGS. 1 to 4, a wheel hub with an axial-braking assembly for a tricycle having a front fork 41 and a front wheel 42 in accordance with the present invention comprises an axle device 10 and a braking device 20.

The axle device 10 is connected to the front fork 41 and the front wheel 42 of the tricycle and has an axle 11, a hub body 12, a wheel mount 13 and a fixing mount 14. The axle 11 is rotatably connected the ends of the front fork 41, is connected to two pedals and has a first end, a second end, an external surface, two bearings 111 and an outer thread 112. The bearings 111 are respectively and rotatably mounted around the axle 11 near the ends of the axle 11 and are respectively connected to the ends of the front fork 41. The outer thread 112 is formed around the external surface of the axle 11 near the second end of the axle 11.

The hub body 12 is connected to the front wheel 42, is mounted around the axle 11 and has a first opening end, a second opening end, an internal surface, two ball bearings 121 and a limiting face 122. The ball bearings 121 are respectively mounted in the internal surface at the opening ends of the hub body 12. The limiting face 122 is formed annularly on the internal surface of the hub body 12 near the ball bearing 121 that is adjacent to the first end of the axle 11.

The wheel mount 13 is securely mounted around the axle 11 near the first end of the axle 11, abuts one of the ball bearings 121 of the hub body 12 and has an inner end and a threaded sleeve 131. The threaded sleeve 131 is formed on and protrudes from the inner end of the wheel mount 13 along the axle 11 and extends into the hub body 12 via the first opening end of the hub body 12 adjacent to the limiting face 122 of the hub body 12.

The fixing mount 14 is mounted around the axle 11, abuts the other ball bearing 121 of the hub 12 and has an outer end, an inner end, a center, a fixing nut 141, a through hole 142 and two inserting slots 143. The outer end of the fixing mount 14 extends out of the hub body 12 adjacent to the outer thread 112 of the axle 11. The inner end of the fixing mount 14 extends into the hub body 12 via the second opening end of the hub body 12. The fixing nut 141 is screwed with the outer thread 112 of the axle 11 and abuts against the outer end of the fixing mount 14 to enable the fixing mount 14 to abut the corresponding ball bearing 121 of the hub body 12. The through hole 142 is formed in the center and through the ends of the fixing mount 14 and is mounted around the axle 11. The inserting slots 143 are formed in the inner end of the fixing mount 14 and communicate with the through hole 142.

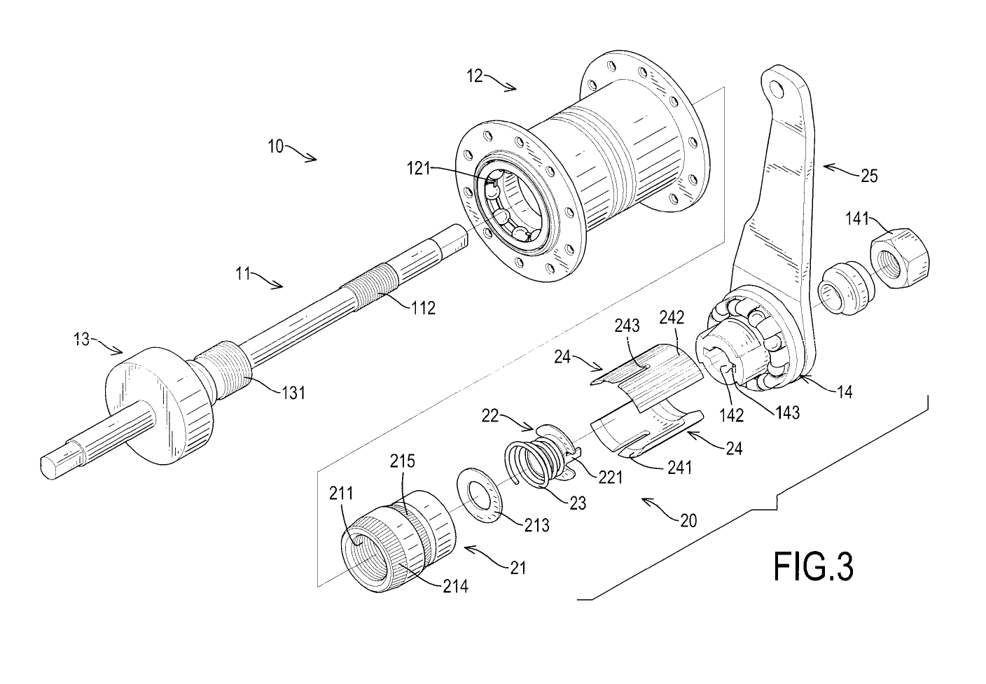

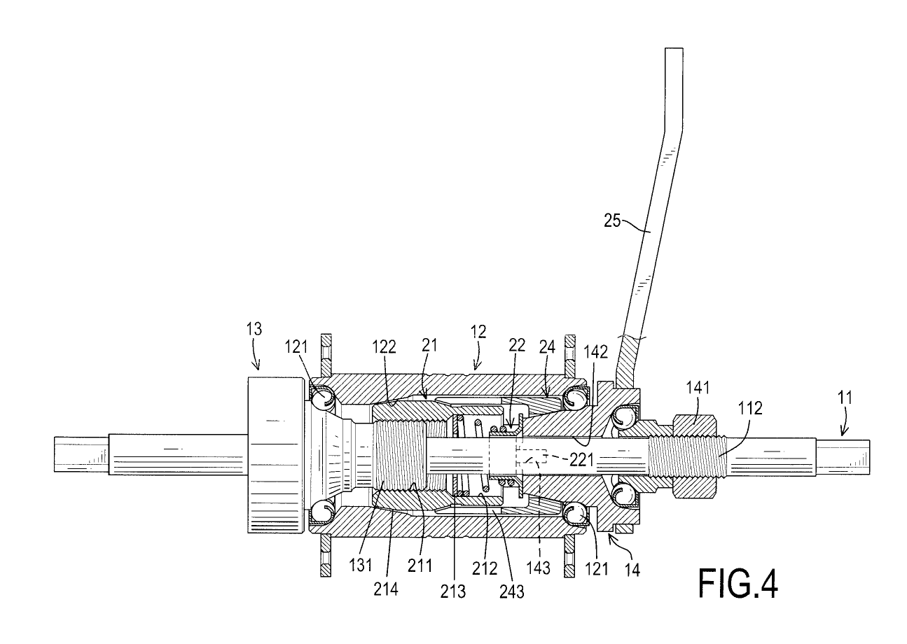

With reference to FIGS. 3 and 4, the braking device 20 is connected to the axle device 10 and has a pressing jacket 21, an engaging mount 22, a spring 23, two friction slices 24 and a holding arm 25.

The pressing jacket 21 is mounted in the hub body 12, is mounted around the axle 11 and is rotatably connected to the wheel mount 13. The pressing jacket 21 is hollow and has an internal surface, an external surface, a connecting end, a mounting end, a middle, an inner thread 211, a chamber 212, a spacer 213, a stopping inclined surface 214 and an abutting inclined surface 215. The connecting end of the pressing jacket 21 is rotatably connected to the threaded sleeve 131 of the wheel mount 13. The mounting end of the pressing jacket 21 extends to the inner end of the fixing mount 14. The inner thread 211 is formed on the internal surface of the pressing jacket 21 near the connecting end of the pressing jacket 21 and is screwed with the threaded sleeve 131 of the wheel mount 13. The chamber 212 is formed in the pressing jacket 21 at the mounting end of the pressing jacket 21.

The spacer 213 is mounted in the chamber 212 and is mounted around the axle 11. The stopping inclined surface 214 is formed around the external surface of the pressing jacket 21 at the connecting end of the pressing jacket 21 and is corresponding to and abuts the limiting face 122 of the hub body 12 when the hub body 12 is rotated. Then, the pressing jacket 21 can be held in the hub body 12 by the stopping inclined surface 214 abutting against the limiting face 122 of the hub 12. The abutting inclined surface 215 is formed around the external surface of the pressing jacket 21 at the middle of the pressing jacket 21. Preferably, the pressing jacket 21 further has multiple notches formed in the inclined surfaces 214, 215 of the pressing jacket 21.

The engaging mount 22 is mounted in the hub body 12, is mounted around the axle 11 and is connected to the fixing mount 14 and has a connecting end, an extending end and two positioning wings 221. The connecting end of the engaging mount 22 abuts the inner end of the fixing mount 14. The extending end of the engaging mount 22 extends in the chamber 212 of the pressing jacket 21. The positioning wings 221 are formed on and protrude from the connecting end of the engaging mount 22 and are respectively mounted in the inserting slots 143 of the fixing mount 14 to hold the engaging mount 22 securely on the fixing mount 14. The spring 23 is securely mounted around the extending end of the engaging mount 22, is mounted in the chamber 212 of the pressing jacket 21 and abuts the spacer 213.

The friction slices 24 are mounted in the hub body 12 near the fixing mount 14 and are mounted around the pressing jacket 21 at intervals, and each friction slice 24 has a friction end, an abutting end, an internal surface, an external surface, a friction inclined plane 241, multiple ribs 242 and a cutting groove 243. The friction end of the friction slice 24 extends toward the abutting inclined surface 215 of the pressing jacket 21. The abutting end of the friction slice 24 abuts the fixing mount 14. The friction inclined plane 241 is formed on the internal surface of the friction slice 24 at the friction end of the friction slice 24 and faces and corresponds to the abutting inclined surface 215 of the pressing jacket 21. The ribs 242 are formed on and protrude from the external surface of the friction slice 24 at intervals and may press against the internal surface of the hub body 12. The cutting groove 243 is formed through the friction end of the friction slice 24 to increase the elastic deformation of the friction slice 24 when the friction slice 24 abuts against the pressing jacket 21. The holding arm 25 is securely mounted around the outer end of the fixing mount 14 and protrudes upwardly to securely connect the front fork 41.

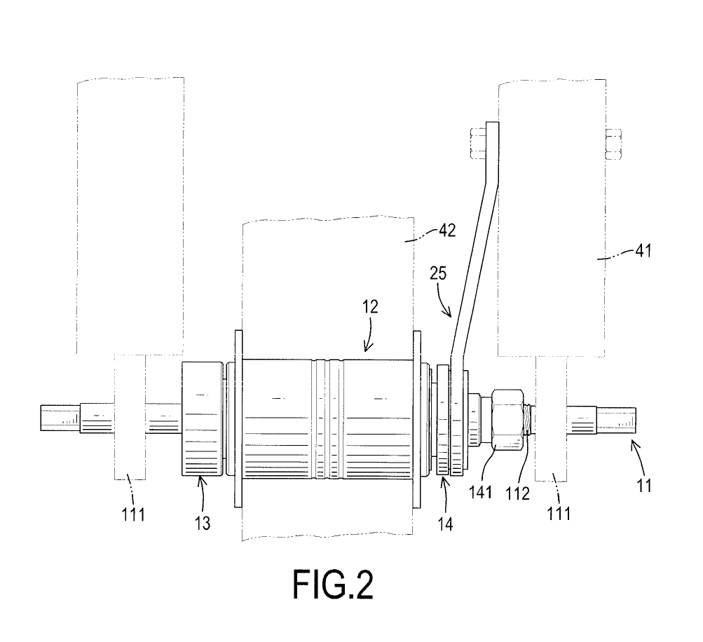

With further reference to FIGS. 2 and 4, the tricycle can be moved forwardly by the feet stepping the pedals of the tricycle in a clockwise direction to rotate the axle 11. When the axle 11 is rotated by the pedals of the tricycle, the wheel mount 13 abuts against the corresponding bearing 121 to enable the hub body 12 to rotate with the wheel mount 13. Then, the front wheel 41 can be rotated with the hub body 12 to enable the tricycle to move forwardly.

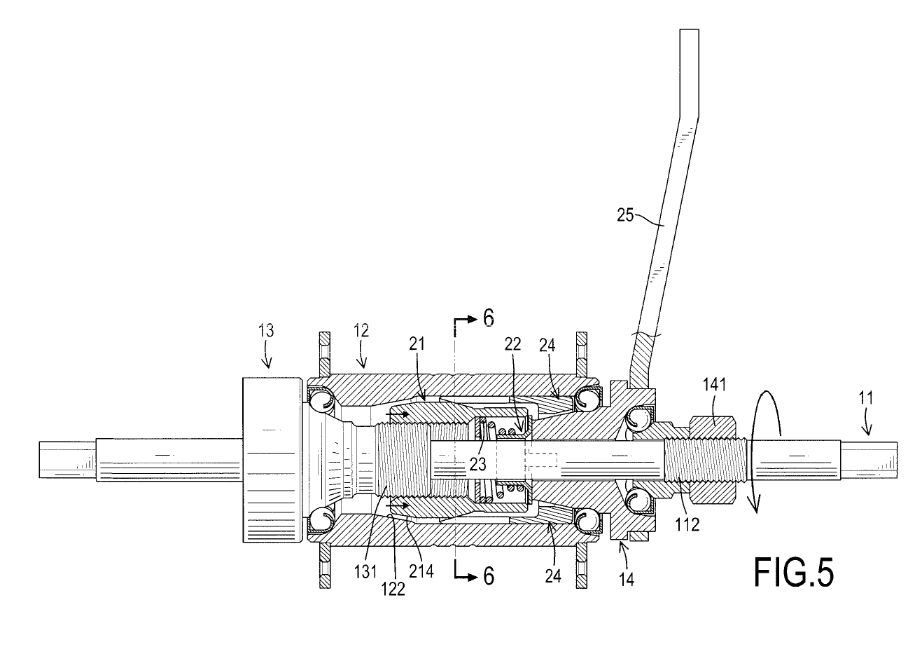

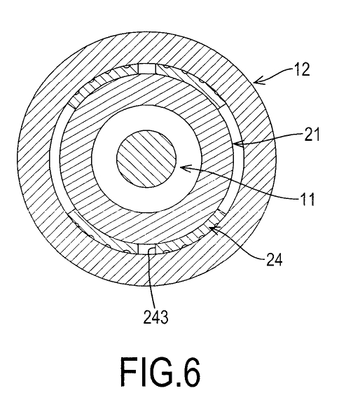

With reference to FIGS. 5 and 6, to stop or slow down the tricycle, the pedals of the tricycle are stepped in a counterclockwise direction and the wheel mount 13 is rotated with the axle 11. When the wheel mount 13 is rotated with the axle 11, the pressing jacket 21 is held by the spring 23 and cannot be rotated with the threaded sleeve 131 of the wheel mount 13 and this will enable the pressing jacket 21 moved toward the fixing mount 14 and compresses the spring 23. When the pressing jacket 21 is moved toward the fixing mount 14, the abutting inclined surface 215 of the pressing jacket 21 will abut with the friction inclined planes 241 of the friction slices 24 and further push the friction slices 24 to deform outwardly. Then, the ribs 242 that are formed on and protrude from the external surface of the friction slices 24 will abut against the internal surface of the hub body 12 to stop the rotation of the hub body 12, and this can provide a braking effect to the front wheel 42 to stop the tricycle conveniently. In addition, when the hub body 12 is stopped by the ribs 242 abutting against the internal surface of the hub body 12, the spring 23 is compressed by the pressing jacket 21 and the threaded sleeve 131 of the wheel mount 13 will not provide a rotating force to the pressing jacket 21. Then, the spring 13 can be recovered to enable the pressing jacket 21 to move the original position.

In addition, during the braking process above-mentioned, the friction slices 24 can be deformed to abut with the internal surface of the hub body 12 closely by the cutting grooves 243 as shown in FIG. 6 when the abutting inclined plane 215 of the pressing jacket 21 abut with the friction inclined planes 241 of the friction slices 24, and this can provide an accurate braking effect to the tricycle.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wheel hub with an axial-braking assembly for a tricycle having a front fork with two ends and a front wheel, and the wheel hub with the axial-braking assembly having
an axle device being adapted to connect to the front fork and the front wheel of the tricycle and having
an axle being adapted to rotatably connect the ends of the front fork and having a first end, a second end and an external surface;
a hub body being adapted to connect to the front wheel, mounted around the axle and having a first opening end, a second opening end and an internal surface;
a wheel mount securely mounted around the axle near the first end of the axle, abutting the hub body and having
an inner end; and
a threaded sleeve formed on and protruding from the inner end of the wheel mount along the axle and extending into the hub via the first opening end of the hub body; and
a fixing mount mounted around the axle, abutting the hub body at the second opening end of the hub body and having
an outer end extending out of the hub body;
an inner end extending into the hub body via the second opening end of the hub body;
a center;
a through hole formed in the center and through the ends of the fixing mount and mounted around the axle; and
two inserting slots formed in the inner end of the fixing mount and communicating with the through hole; and
a braking device connected to the axle device and having
a pressing jacket mounted in the hub body, mounted around the axle and rotatably connected to the wheel mount and having
an internal surface;
an external surface;
a connecting end rotatably connected to the threaded sleeve of the wheel mount;
a mounting end extending to the inner end of the fixing mount;
a middle;
an inner thread formed on the internal surface of the pressing jacket near the connecting end of the pressing jacket and screwed with the threaded sleeve of the wheel mount;
a chamber formed in the pressing jacket at the mounting end of the pressing jacket; and
an abutting inclined plane formed around the external surface of the pressing jacket at the middle of the pressing jacket;
an engaging mount mounted in the hub body, mounted around the axle and connected to the fixing mount and having
a connecting end abutting the inner end of the fixing mount;
an extending end extending in the chamber of the pressing jacket; and
two positioning wings formed on and protruding from the connecting end of the engaging mount and respectively mounted in the inserting slots of the fixing mount to hold the engaging mount securely on the fixing mount;
a spring securely mounted around the extending end of the engaging mount and mounted in the chamber of the pressing jacket;
two friction slices mounted in the hub body near the fixing mount and mounted around the pressing jacket at intervals, and each friction slice having
a friction end extending toward the abutting inclined plane of the pressing jacket;
an abutting end abutting the fixing mount;
an internal surface; and
an external surface; and
a holding arm securely mounted around the outer end of the fixing mount and protrudes upwardly to securely connect the front fork.

2. The wheel hub with the axial-braking assembly as claimed in claim 1, wherein each one of the friction slices has
a friction inclined plane formed on the internal surface of the friction slice at the friction end of the friction slice and facing and corresponding to the abutting inclined surface of the pressing jacket; and
a cutting groove formed through the friction end of the friction slice to increase the elastic deformation of the friction slice.

3. The wheel hub with the axial-braking assembly as claimed in claim 2, wherein
the axle has an outer thread formed around the external surface of the axle near the second end of the axle;
the hub body has two ball bearings respectively mounted in the internal surface at the opening ends of the hub body;
the fixing mount has a fixing nut screwed with the outer thread of the axle and abutting against the outer end of the fixing mount to enable the fixing mount to abut the ball bearing that is mounted in the second opening end of the hub body; and
the wheel mount abuts the ball bearing that is mounted in the first opening end of the hub body.

4. The wheel hub with the axial-braking assembly as claimed in claim 3, wherein
the hub body has a limiting face formed annularly on the internal surface of the hub body near the ball bearing that is adjacent to the first end of the axle;
the threaded sleeve of the wheel mount extends into the hub adjacent to the limiting face of the hub; and
the pressing jacket has a stopping inclined surface formed around the external surface of the pressing jacket at the connecting end of the pressing jacket and corresponding to the limiting face of the hub.

5. The wheel hub with the axial-braking assembly as claimed in claim 4, wherein the pressing jacket has multiple notches formed on the stopping inclined surface and the abutting inclined surface of the pressing jacket.

6. The wheel hub with the axial-braking assembly as claimed in claim 5, wherein
the pressing jacket has a spacer mounted in the chamber and mounted around the axle; and
the spring is mounted in the chamber of the pressing jacket and abuts the spacer.

7. The wheel hub with the axial-braking assembly as claimed in claim 6, wherein each friction slice has multiple ribs formed on and protruding from the external surface of the friction slice at intervals to press against the internal surface of the hub body.

8. The wheel hub with the axial-braking assembly as claimed in claim 7, wherein the axle has two bearings respectively and rotatably mounted around the axle near the ends of the axle to respectively connect to the ends of the front fork.

9. The wheel hub with the axial-braking assembly as claimed in claim 1, wherein each friction slice has multiple ribs formed on and protruding from the external surface of the friction slice at intervals to press against the internal surface of the hub body.

10. The wheel hub with the axial-braking assembly as claimed in claim 1, wherein the axle has two bearings respectively and rotatably mounted around the axle near the ends of the axle to respectively connect to the ends of the front fork.
